(19) United States
(12) Patent Application Publication
(10) Pub. No.: US 2015/0130417 A1
(43) Pub. Date: May 14, 2015

(54) METHOD OF CHARGING BATTERY AND BATTERY CHARGING SYSTEM

(71) Applicant: Samsung SDI Co., Ltd., Yongin-si (KR)

(72) Inventors: Subin SONG, Yongin-si (KR); Joosick Jung, Yongin-si (KR); Myoungseok Lee, Yongin-si (KR); Dmitry Golovanov, Yongin-si (KR)

(73) Assignee: Samsung SDI Co., Ltd., Yongin-si (KR)

(21) Appl. No.: 14/219,963

(22) Filed: Mar. 19, 2014

(30) Foreign Application Priority Data
Nov. 12, 2013 (KR) 10-2013-0136937

(51) Int. Cl. H02J 7/00

(52) U.S. Cl. CPC H02J 7/007; H02J 7/0052
USPC 320/112; 320/160; 320/107

(57) ABSTRACT

A method of charging batteries and a battery charging system are disclosed. One inventive aspect includes a battery pack and a charging unit. The battery pack further comprises a battery cell, a voltage sensor and a current sensor. The charging unit is configured to charge the battery cell with a constant current or a constant voltage at least partially based on the voltage of the battery cell sensed by the voltage sensor.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to and the benefit of Korean Patent Application No. 10-2013-0136937, filed on Nov. 12, 2013, the entire content of which is incorporated herein by reference.

### BACKGROUND

1. Field

Aspects of the disclosed technology relate to a method of charging batteries and a battery charging system for a quick and stable charge.

2. Description of the Related Technology

In general, a non-rechargeable battery is referred to as a primary battery, and a rechargeable battery, which is reusable and can be recharged even when it is discharged, is referred to as a secondary battery.

With the proliferation of feature phones, smart phones, PDA phones, digital cameras, notebook computers, electronic tools, hybrid vehicles and electric vehicles, the demand for secondary batteries is rapidly growing.

Secondary batteries are typically charged by a constant-current mode charging method and a constant-voltage mode charging method. This means, the secondary battery will be charged with a constant current until the voltage of the battery increases to near a full charge at first. After this, the battery will be charged with a constant voltage and thereby, a reduced charging current.

### SUMMARY OF CERTAIN INVENTIVE ASPECTS

Aspects of the disclosed technology provide a method of charging batteries and a battery charging system, which can achieve stable, rapid charging.

In accordance with one aspect of the disclosed technology, there is provided a method of charging batteries, including a first high constant-current charging step of charging a battery cell with a first current, a first low constant-current charging step of charging the battery cell with a second current, a second high constant-current charging step of charging the battery cell with a third current and a second low constant-current charging step of charging the battery cell with a fourth current.

In the first and second low constant-current charging steps, the battery cell can be charged with a lower current than in the first and second high constant-current charging steps.

The second current can be set to be lower than the first current.

The third current can be set to be lower than the first current and higher than the second current.

The fourth current can be set to be lower than the second current.

An increase in the voltage of the battery cell in the first and second low constant-current charging steps can be smaller than an increase in the voltage of the battery cell in the first and second high constant-current charging steps.

In the first high constant-current charging step, while charging the battery cell with the first current, a voltage of the battery cell can be sensed to determine whether the voltage of the battery cell reaches a first reference voltage, and if the voltage of the battery cell reaches the first reference voltage, the first low constant-current charging step is performed.

In the first low constant-current charging step, while charging the battery cell with the second current, a voltage of the battery cell can be sensed to determine whether the voltage of the battery cell reaches a second reference voltage, and if the voltage of the battery cell reaches the second reference voltage, the second high constant-current charging step is performed.

In the second high constant-current charging step, while charging the battery cell with a third current, a voltage of the battery cell can be sensed to determine whether the voltage of the battery cell reaches a third reference voltage, and if the voltage of the battery cell reaches the third reference voltage, the second low constant-current charging step is performed.

In the second low constant-current charging step, while charging the battery cell with a fourth current, a voltage of the battery cell can be sensed to determine whether the voltage of the battery cell reaches a fourth reference voltage, and if the voltage of the battery cell reaches the fourth reference voltage, charging with a constant voltage is further performed to maintain the fourth reference voltage.

In accordance with another aspect of the disclosed technology, there is provided a battery charging system including a battery pack including a battery cell, a voltage sensor sensing a voltage of the battery cell, and a current sensor sensing a charging current for charging the battery cell; and a charging unit constant-current charging the battery cell with a first current, constant-current charging the battery cell with a second current if the voltage of the battery cell reaches a first reference voltage, constant-current charging the battery cell with a third current if the voltage of the battery cell reaches a second reference voltage, and constant-current charging the battery cell with a fourth current if the voltage of the battery cell reaches a third reference voltage.

The second and fourth currents can be set to be lower than the first and third currents.

The second current can be set to be lower than the first current.

The third current can be set to be lower than the first current and higher than the second current.

The fourth current can be set to be lower than the second current.

A difference between the first reference voltage and the second reference voltage can be smaller than that between the second reference voltage and the third reference voltage.

If a voltage of the battery cell reaches a fourth reference voltage, the charging unit can charge the battery cell with a constant voltage to maintain the fourth reference voltage.

As described above, in the battery charging method according to some embodiments of the disclosed technology, the conventional constant-current-constant-voltage charging mode is replaced by a high constant-current-lowconstant-current charging mode. That is to say, a low constant-current mode for charging with a relatively low current is adopted in a constant-voltage period, thereby charging a battery cell stably and rapidly.

Additional aspects and/or advantages of the invention will be set forth in part in the description which follows and, in part, will be obvious from the description, or can be learned by practice of the invention.

### BRIEF DESCRIPTION OF THE DRAWINGS

The objects, features and advantages of the disclosed technology will be more apparent from the following detailed description in conjunction with the accompanying drawings, in which:

FIG. 1 is a flowchart schematically illustrating a method of charging batteries according to an exemplary embodiment of the disclosed technology;

FIG. 2 is a graph illustrating changes in voltage, current and capacitance;

FIG. 3 is a block diagram of a battery system according to an exemplary embodiment of the disclosed technology; and

FIG. 4 is a flowchart specifically illustrating the charging method shown in FIG. 1.

### DETAILED DESCRIPTION OF CERTAIN INVENTIVE EMBODIMENTS

Hereinafter, examples of embodiments of the invention will be described in detail with reference to the accompanying drawings such that they can easily be made and used by those skilled in the art.

In the following description, technical terms are used only to explain a specific exemplary embodiment while not limiting the disclosed technology. The terms of a singular form may include plural forms unless referred to the contrary. The terms “include,” “comprise,” “including,” and “comprising,” as used herein, specify a component, a process, an operation, and/or an element but do not exclude other components, processes, operations, and/or elements. It will be understood that although the terms “first” and “second” are used herein to describe various elements, these elements should not be limited by these terms. These terms are only used to distinguish one component from other components.

It will be understood that when a layer, region, or component is referred to as being “formed on,” another layer, region, or component, it can be directly or indirectly formed on the other layer, region, or component. That is, for example, intervening layers, regions, or components may be present.

The drawings and description are to be regarded as illustrative in nature and not restrictive. Like reference numerals designate like elements throughout the specification.

Further, since sizes and thicknesses of constituent members shown in the accompanying drawings are arbitrarily given for better understanding and ease of description, the disclosed technology is not limited to the illustrated sizes and thicknesses.

In the drawings, the thickness of layers, films, panels, regions, etc., are exaggerated for clarity. In the drawings, for better understanding and ease of description, the thicknesses of some layers and areas are exaggerated. It will be understood that when an element such as a layer, film, region, or substrate is referred to as being “on” another element, it is directly on the other element or intervening elements may also be present.

Throughout this specification and the claims that follow, when it is described that an element is “connected” to another element, the element is “directly connected” to the other element or “electrically connected” to the other element through a third element. In addition, unless explicitly described to the contrary, the word “comprise” and variations such as “comprises” or “comprising” will be understood to imply the inclusion of stated elements but not the exclusion of any other elements. Throughout this specification, it is understood that the term “on” and similar terms are used generally and are not necessarily related to a gravitational reference.

Here, when a first element is described as being connected to a second element, the first element is not only directly connected to the second element but may also be indirectly connected to the second element via a third element. Further, some of the elements that are not essential to the complete understanding of the disclosed technology are omitted for clarity. Also, like reference numerals refer to like elements throughout.

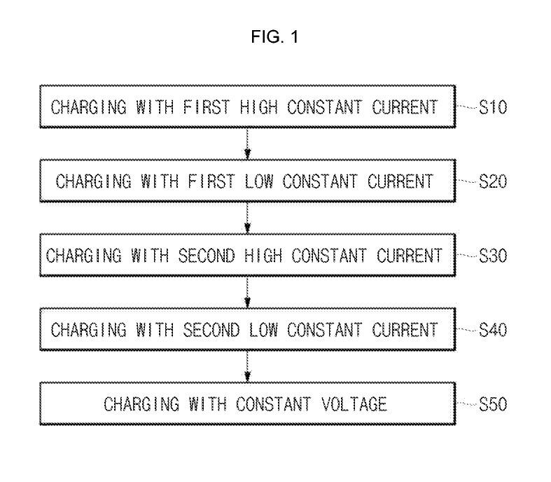

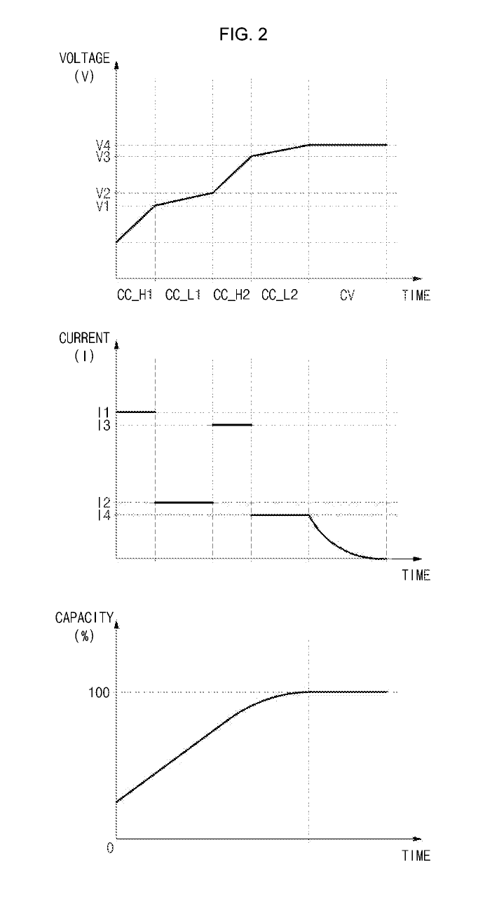

FIG. 1 is a flowchart schematically illustrating a method of charging batteries according to an embodiment of the disclosed technology and FIG. 2 is a graph illustrating changes in voltage, current and capacitance.

As shown in FIG. 1, the battery charging method according to an embodiment of the disclosed technology includes charging with a first high constant current (S10), charging with a first low constant current (S20), charging with a second high constant current (S30), and charging with a second low constant current (S40). The battery charging method according to an embodiment of the disclosed technology further includes charging with a constant voltage (S50).

Here, the number of high constant-current charging stages and low constant-current charging stages may be smaller than or greater than the number illustrated herein, but aspects of the disclosed technology are not limited thereto. The number of high constant-current charging stages and low constant-current charging stages may vary according to the capacity or characteristic of a battery cell.

In the charging with the first high constant current (S10), as shown in FIG. 2, the battery cell is charged in a constant-current mode (CC_H1). That is to say, in the charging with the first high constant current (S10), the battery cell is charged with a first current (I1) until a voltage of the battery cell (increases and) reaches a predetermined first reference voltage (V1). The first current (I1) is a relatively high current.

In the charging with the first high constant current (S10), the charging current is constant and the voltage of the battery cell gradually increases. Here, the voltage of the battery cell constantly increases with a first slope. In addition, since the first current (I1) is a relatively high current, the first slope is also relatively large. With the lapse of charging time, charging capacity of the battery cell gradually increases (see FIG. 2).

In the charging with the first low constant current (S20), as shown in FIG. 2, the battery cell is charged in a constant-current mode (CC_L1). That is to say, in the charging with the first low constant current (S20), the battery cell is charged with a second current (I2) until a voltage of the battery cell (increases and) reaches a predetermined second reference voltage (V2). Here, since the voltage of the battery cell gradually increases with the lapse of charging time, the second reference voltage (V2) is set to be greater than the first reference voltage (V1), that is, V2>V1. In addition, the second current (I2) is much lower than the first current (I1), that is, I2<I1. Therefore, in the charging with the first low constant current (S20), an increase in the voltage is much smaller than that in the charging with the first high constant current (S 10).

In the charging with the first low constant current (S20), the charging current is constant and the voltage of the battery cell gradually increases. Here, the voltage of the battery cell constantly increases with a second slope. In addition, since the second current (I2) is much lower than the first current (I1), the second slope is also smaller than the first slope. With the lapse of charging time, charging capacity of the battery cell gradually increases (see FIG. 2).

As described above, in the charging method according to the disclosed technology, the conventional constant-current constant-voltage charging mode is replaced by a high-constant-current low-constant-current charging mode, so that constant-current charging is performed to have an increasing voltage even in the conventional constant-voltage period, thereby shortening a charging time. Here, in a low constant-current period replacing a constant-voltage period, charging is performed with a relatively low current, thereby charging the battery cell in a stable manner.

In the charging with the second high constant current (S30), the battery cell is charged in a constant-current mode (CC_H2). That is to say, in the charging with the second high constant current (S30), the battery cell is charged with a third current (I3) until a voltage of the battery cell (increases and) reaches a predetermined third reference voltage (V3). Here, since the voltage of the battery cell gradually increases with the lapse of charging time, the third reference voltage (V3) is set to be greater than the second reference voltage (V2), that is, V2>V2. In addition, since a charging current supplied to the battery cell is reduced with the lapse of charging time, the third current (I3) is set to be smaller than the first current (I1), that is, I3<I1. However, since the third current (I3) is a current in a high-constant-current period, it is set to be greater than the second current (I2), that is, I3>I2. That is to say, the third current (I3) is set to be smaller than the first current (I1) and greater than the second current (I2) (I2<I3<I1). In addition, in the charging with the second high constant current (S30), the voltage of the battery cell constantly increases with a third slope. The third slope is set to be smaller than the first slope and greater than the second slope.

In the charging with the second low constant current (S40), the battery cell is charged in a constant-current mode (CC_L2). That is to say, in the charging with the second low constant current (S40), the battery cell is charged with a fourth current (I4) until a voltage of the battery cell (increases and) reaches a predetermined fourth reference voltage (V4). Here, since the voltage of the battery cell gradually increases with the lapse of charging time, the fourth reference voltage (V4) is set to be greater than the third reference voltage (V3), that is, V4>V3. In addition, the fourth current (I4) is much lower than the first current (I1) and the third current (I3) in the high-constant-current period and is set to be lower than the second current (I2) in the low-constant-current period (I4<I2<I3<I1).

That is to say, in the charging with the first and second low constant currents (S20, S40) corresponding to the conventional constant-voltage charging period, the battery cell is charged with a lower current than in the charging with the first and second high constant currents (S10, S30).

In the charging with the constant voltage (S50), as described above, if the voltage of the battery cell reaches the predetermined fourth reference voltage (V4), charging is performed with a constant voltage to maintain the fourth reference voltage (V4). In the charging with the constant voltage (S50), the charging current gradually decreases, as shown in FIG. 2.

As described above, in the charging method according to the embodiment of the disclosed technology, in a constant-current-constant-voltage charging mode, a low-constant-current mode for charging with a relatively low current is adopted in a constant-voltage period, thereby charging a battery cell stably and rapidly.

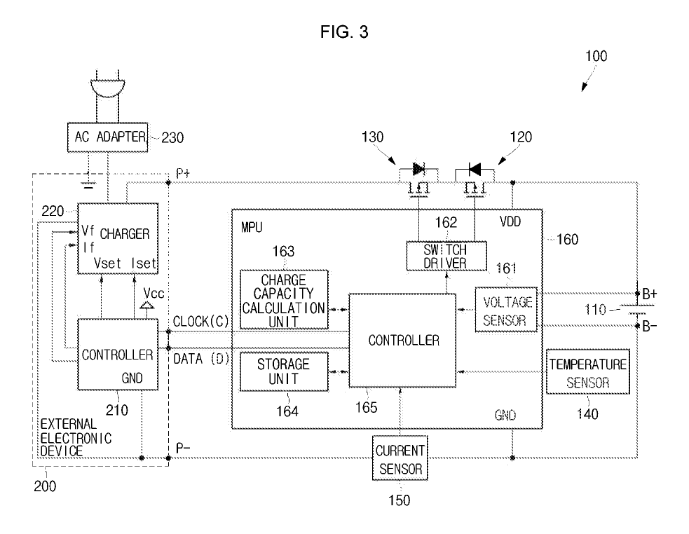

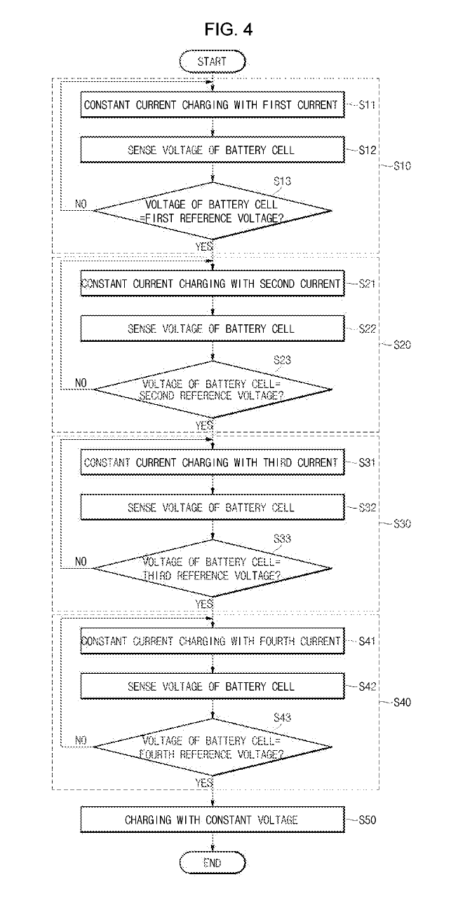

FIG. 3 is a block diagram of a battery system according to an embodiment of the disclosed technology, and FIG. 4 is a flowchart specifically illustrating the charging method shown in FIG. 1

As shown in FIG. 3, the battery charging system 100 according to the embodiment of the disclosed technology includes a battery cell 110, a charge switch 120, a discharge switch 130, a temperature sensor 140, a current sensor 150 and a micro processor unit (MPU) 160. This may also be defined as a battery pack. In addition, the battery charging system 100 is connected to an external electronic device 200 through pack terminals P+ and P− and communication terminals C and D. Here, in some exemplary implementations, the external electronic device 200 includes a mobile phone, a smart phone, a notebook computer, and/or an electronic tool capable of charging. The external electronic device 200 itself may be a charger.

In some exemplary implementations, the battery cell 110 is generally a chargeable secondary battery, such as a lithium ion battery, or a lithium ion polymer battery, but not limited thereto. In addition, in the illustrated embodiment, one battery cell 110 is exemplified, but a plurality of battery cells are connected to each other in series or in parallel.

The charge switch 120 may be installed between a positive terminal B+ of the battery cell 110 and a pack positive terminal P+. When the battery cell 110 is overcharged, the charge switch 120 is turned off by a control signal of the MPU 160, thereby preventing the battery cell 110 from being overcharged. The charge switch 120 may be a general MOSFET or a relay, but aspects of the disclosed technology are not limited thereto.

The discharge switch 130 may also be installed between the positive terminal B+ of the battery cell 110 and the pack positive terminal P+. When the battery cell 110 is overdischarged, the discharge switch 130 is turned off by a control signal of the MPU 160, thereby preventing the battery cell 110 from being overdischarged. The discharge switch 130 may be a general MOSFET or a relay, but aspects of the disclosed technology are not limited thereto.

The temperature sensor 140 may be directly attached to the battery cell 110 or may be installed around the battery cell 110 to sense a temperature of the battery cell 110 or an ambient temperature of the battery cell 110. The sensing result is transmitted to the MPU 160. In some exemplary implementation, the temperature sensor 140 includes a thermistor, but aspects of the disclosed technology are not limited thereto.

The current sensor 150 may be installed between a negative terminal B− of the battery cell 110 and a pack negative terminal P−. The current sensor 150 may sense a charging current and a discharging current of the battery cell 110. The current sensor 150 may transmit the sensing result to the MPU 160. The current sensor 150 may be a general sensor resistor, but aspects of the disclosed technology are not limited thereto.

The MPU 160 includes a voltage sensor 161, a switch driver 162, a charge capacity calculation unit 163, a storage unit 164 and a controller 165. The voltage sensor 161 is connected to the battery cell 110 in parallel and senses a voltage of the battery cell 110. The voltage sensor 161 then converts the same into a digital signal to then be transmitted to the controller 165. Here, the current obtained from the current sensor 150 and the temperature obtained from the temperature sensor 140 are also converted into digital signals. The digital signals are transmitted to the controller 165. In addition, a switch driver 162 turns on or off the charge switch 120 and/or the discharge switch 130 by a control signal from the controller 165. That is to say, the controller 165 controls the switch driver 162 based on data obtained from the temperature sensor 140, the current sensor 150 and the voltage sensor 161.

In addition, if it is determined based on the data obtained from the current sensor 150 that an overcurrent flows in the battery cell 110, the controller 165 transmits the control signal to the switch driver 162 to turn off the charge switch 120 or the discharge switch 130. In addition, if it is determined based on the data obtained from the voltage sensor 161 that the battery cell 110 is overcharged and/or overdischarged, the controller 165 transmits the control signal to the switch driver 162 to turn off the charge switch 120 or the discharge switch 130.

The charge capacity calculation unit 163 calculates a charge capacity of the battery cell 110 based on data obtained from the voltage sensor 161. To this end, the storage unit 164 may pre-store information regarding charge capacity relative to the voltage of the battery cell 110 in the form of a lookup table.

As described above, the storage unit 164 may store the charge capacity relative to the voltage of the battery cell 110, a normal charging voltage range, a normal discharging voltage range, normal charge/discharging current ranges, first, second, third and fourth reference voltages V1, V2, V3 and V4, and first, second, third and fourth currents I1, I2, I3 and I4. The data stored in the storage unit 164 may be supplied to the controller 165. In addition, the storage unit 164 may also store software or a program for implementing the charging method shown in FIGS. 1 and/or 4.

As described above, the controller 165 operates the switch driver 162 using the data obtained from the temperature sensor 140, the current sensor 150 and the voltage sensor 161 or transmits data of target charging voltage (Vset) and/or target charging current (Iset) of the battery cell 110 to the external electronic device 200 through the terminal communications C and D using the data regarding the first, second, third and fourth reference voltages V1, V2, V3 and V4, and the first, second, third and fourth currents I1, I2, I3 and I4.

In addition, in the illustrated embodiment, the voltage sensor 161 and the switch driver 162 are controlled by the controller 165 of the MPU 160. However, the number of battery cells 110 increases, a separate analog front end is obviously installed to control the voltage sensor 161 and the switch driver 162. Alternatively, the MPU 160 and the analog front end may be separately provided or may be incorporated into a single chip.

Meanwhile, the external electronic device 200 includes a controller 210 and a charger 220. The controller 210 transmits the data of target charging voltage (Vset) and/or target charging current (Iset) to the charger 220 based on the data obtained from the terminal communications C and D of the battery pack 100. Then, the charger 220 supplies the charging voltage and/or charging current corresponding to the charging voltage (Vset) and/or charging current (Iset) to the battery pack 100. In addition, the controller 210 receives the voltage and current data (Vf, If) fed back from the battery pack 100 and transmits the same to the charger 220, thereby controlling the charger 220 to charge the battery cell 110 in a feedback manner. Here, an AC adapter 230 converting AC power into DC power may be connected to the charger 220.

The operation of the battery charging system according to the disclosed technology will be described with reference to FIGS. 3 and 4.

In some exemplary implementations, when a user electrically connects the AC adapter 230 to an AC power supply, the operation of the battery charging system 100 starts.

First, the controller 165 of the battery pack 100 transmits the data of target charging voltage (Vset) and/or charging current (Iset) of the battery cell 110 to the controller 210 using the data regarding the first, second, third and fourth reference voltages V1, V2, V3 and V4 and the first, second, third and fourth currents I1, 12, 13 and 14. As such, in one exemplary implementation, the controller 210 controls the charger 220 to charge the battery cell 110 with the first current (I1) in a constant-current mode (S11).

As described above, when constant-current charging is performed with the first current (I1), the controller 165 of the battery pack 100 controls the voltage sensor 161 to sense a voltage of the battery cell 110 (S12). The controller 165 of the battery pack 100 determines whether the sensed voltage of the battery cell 110 reaches the predetermined first reference voltage (V1) (S13).

If the voltage of the battery cell 110 reaches the predetermined first reference voltage (V1), the controller 165 of the battery pack 100 updates the data of the battery cell 110 (the data of target charging voltage (Vset) and/or charging current (Iset) of the battery cell 110) and retransmits the updated data to the controller 210 of the external electronic device 200, thereby allowing the controller 210 of the external electronic device 200 to control the charger 220 to charge the battery cell 110 with the second current (I2) in a constant-current mode (S21).

As described above, when constant-current charging is performed with the second current (I2), the controller 165 of the battery pack 100 controls the voltage sensor 161 to sense the voltage of the battery cell 110 (S22). The controller 165 of the battery pack 100 determines whether the sensed voltage of the battery cell 110 reaches the predetermined second reference voltage (V2) (S23).

If the voltage of the battery cell 110 reaches the second reference voltage (V2), the controller 165 of the battery pack 100 updates the data of the battery cell 110 (the data of target charging voltage (Vset) and/or target charging current (Iset)) and retransmits the updated data to the controller 210 of the external electronic device 200, thereby allowing the controller 210 of the external electronic device 200 to control the charger 220 to charge the battery cell 110 with the third current (I3) in a constant-current mode (S31).

As described above, when constant-current charging is performed with the third current (I3), the controller 165 of the battery pack 100 controls the voltage sensor 161 to sense a voltage of the battery cell 110 (S32). The controller 165 of the battery pack 100 determines whether the sensed voltage of the battery cell 110 reaches the predetermined third reference voltage (V3) (S33).

If the voltage of the battery cell 110 reaches the predetermined third reference voltage (V3), the controller 165 of the battery pack 100 updates the data of the battery cell 110 (the data of target charging voltage (Vset) and/or charging current (Iset) of the battery cell 110) and retransmits the updated data to the controller 210 of the external electronic device 200, thereby allowing the controller 210 of the external electronic device 200 to control the charger 220 to charge the battery cell 110 with the fourth current (I4) in a constant-current mode (S41).

As described above, when constant-current charging is performed with the fourth current (I4), the controller 165 of the battery pack 100 controls the voltage sensor 161 to sense a voltage of the battery cell 110 (S42). The controller 165 of the battery pack 100 determines whether the sensed voltage of the battery cell 110 reaches the predetermined fourth reference voltage (V4) (S56).

If the voltage of the battery cell 110 reaches the predetermined fourth reference voltage (V4), the controller 165 of the battery pack 100 controls the battery cell 110 to be charged with a constant voltage to maintain the fourth reference voltage (V4) (S50).

Here, the first reference voltage (V1) is set to be smaller than the second reference voltage (V2), the second reference voltage (V2) is set to be smaller than the third reference voltage (V3). The third reference voltage (V3) is set to be smaller than the fourth reference voltage (V4) (V1<V2<V3<V4). In addition, the first current (I1) is set to be greater than the second current (I2), the second current (I2) is set to be smaller than the third current (I3), the third current (I3) is set to be smaller than the first current (I1) and greater than the second current (I2). The fourth current (I4) is set to be smaller than the second current (I2) (I1>I3>I2>I4).

In the foregoing description, the controller 165 of the battery pack 100 transmits the data of target voltage and/or target current of the battery cell 110 to the controller 210 of the external electronic device 200. However, in some cases, the controller 210 of the external electronic device 200 may directly determine the target voltage and/or target current of the battery cell 110. That is to say, the controller 165 of the battery pack 100 transmits basic information about the battery cell 110 to the controller 210 of the external electronic device. The information includes voltage, current, charge capacity, or temperature of the battery cell 110. The controller 210 of the external electronic device 200 may determine a target voltage and/or a target current of the battery cell 110. To this end, the controller 210 of the external electronic device may require additional software and hardware.

Various modifications of the above described embodiments will be readily apparent, and the generic principles defined herein are applied to other embodiments without departing from the spirit or scope of the disclosed technology. Thus, the disclosed technology is not intended to be limited to the embodiments shown herein but is to be accorded the widest scope consistent with the principles and novel features disclosed herein.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the disclosed technology have been described with reference to the figures, it will be understood by those of ordinary skill in the art that various changes in form and details may be made therein without departing from the spirit and scope of the disclosed technology as defined by the following claims.

What is claimed is:

1. A method of charging a battery, comprising:
charging a battery cell with a first current with a first high-constant current;
charging the battery cell with a second current with a first low-constant current;
charging the battery cell with a third current with a second high-constant current; and
charging the battery cell with a fourth current with a second low-constant current.

2. The method of claim 1, wherein at least one of the second current or the fourth current is lower than the first current and the third current.

3. The method of claim 1, wherein the second current is set to be lower than the first current.

4. The method of claim 1, wherein the third current is set to be lower than the first current and higher than the second current.

5. The method of claim 1, wherein the fourth current is set to be lower than the second current.

6. The method of claim 1, wherein an increase in the voltage of the battery cell in the first and second low constant-current charging steps is smaller than an increase in the voltage of the battery cell in the first and second high constant-current charging steps.

7. The method of claim 1, further comprising sensing a voltage of the battery cell to determine whether the voltage reaches a first reference voltage when charging the battery cell with the first current, wherein the first high-constant-current charging is done and the first low-constant-current charging is performed when the voltage reaches the first reference voltage.

8. The method of claim 1, further comprising sensing a voltage of the battery cell to determine whether the voltage reaches a second reference voltage when charging the battery cell with the second current, wherein the first low-constant-current charging is done and the second high-constant-current charging is performed when the voltage reaches the second reference voltage.

9. The method of claim 1 further comprising sensing a voltage of the battery cell to determine whether the voltage reaches a third reference voltage when charging the battery cell with the third current, wherein the second high-constant-current charging is done and the second low-constant-current charging is performed when the voltage reaches the third reference voltage.

10. The method of claim 1 further comprising sensing a voltage of the battery cell to determine whether the voltage reaches a fourth reference voltage when charging the battery cell with the fourth current, wherein the second low-constant-current charging step is done when the voltage reaches the fourth reference voltage.

11. The method of claim 10, further comprising:
charging the battery cell with a constant voltage to maintain the voltage to be the fourth reference voltage when the voltage of the battery cell reaches the fourth reference voltage.

12. A battery charging system, comprising:
a battery pack including:
a battery cell,
a voltage sensor configured to sense a voltage of the battery cell, and
a current sensor configured to sense a charging current of the battery cell; and
a charging unit configured to constant-current charge the battery cell, the charging unit further configured to:
constant-current charging the battery cell with a first current,
constant-current charge the battery cell with a second current if the voltage of the battery cell reaches a first reference voltage,
constant-current charge the battery cell with a third current if the voltage of the battery cell reaches a second reference voltage, and
constant-current charge the battery cell with a fourth current if the voltage of the battery cell reaches a third reference voltage.

13. The battery charging system of claim 12, wherein the second and fourth currents are set to be lower than the first and third currents.

14. The battery charging system of claim 12, wherein the second current is set to be lower than the first current.

15. The battery charging system of claim 12, wherein the third current is set to be lower than the first current and higher than the second current.

16. The battery charging system of claim 12, wherein the fourth current is set to be lower than the second current.

17. The battery charging system of claim 12, wherein a difference between the first reference voltage and the second reference voltage is smaller than that between the second reference voltage and the third reference voltage.

18. The battery charging system of claim 12, wherein if a voltage of the battery cell reaches a fourth reference voltage, the charging unit charges the battery cell with a constant voltage to maintain the fourth reference voltage.

19. A charging apparatus for charging a battery cell, comprising:
means for sensing a voltage of the battery cell, and
means for sensing a charging current of the battery cell; and
means for constant-current charging the battery cell, wherein means for constant-current charging the battery cell further include:
means for constant-current charging the battery cell with a first current,
means for constant-current charging the battery cell with a second current if the voltage of the battery cell reaches a first reference voltage,
means for constant-current charging the battery cell with a third current if the voltage of the battery cell reaches a second reference voltage, and
means for constant-current charging the battery cell with a fourth current if the voltage of the battery cell reaches a third reference voltage.

20. The charging apparatus of claim 19, wherein means for constant-current charging the battery cell further comprises means for charging the battery cell with a constant voltage to maintain the fourth reference voltage if the voltage of the battery cell reaches a fourth reference voltage.
